(19) United States
(12) Patent Application Publication
(10) Pub. No.: US 2021/0284861 A1
(43) Pub. Date: Sep. 16, 2021

(54) AQUEOUS TIRE DRESSING COMPOSITION AND METHOD OF TREATING A SURFACE WITH THE SAME

(71) Applicant: Dura-Coating Technology, Inc., Naples, FL (US)

(72) Inventor: Mark Messina, Naples, FL (US)

(21) Appl. No.: 16/818,265

(22) Filed: Mar. 13, 2020

(51) Int. Cl. C09D 133/08

(52) U.S. Cl. CPC C09D 133/08

(57) ABSTRACT

The present invention relates to an aqueous tire dressing composition comprising an acrylic resin, a polyacrylate, and a liquid carrier, and also to a method of treating a surface of a tire. The method of treating a surface of a tire comprises applying a first coat of the aqueous tire dressing composition to the surface of the tire, allowing the aqueous tire dressing to dry for an effective period of drying time, applying a second coat of the aqueous tire dressing composition to the surface of the tire, and allowing the aqueous tire dressing to cure for an effective period of curing time for achieving a clear, tack-free protective layer on the surface of the tire.

### BACKGROUND OF THE INVENTION

### Field of the Invention

The present invention relates generally to an aqueous tire dressing composition and to a method of treating a rubber surface using the aqueous tire dressing. More particularly, the present invention relates to an aqueous tire dressing composition and method for imparting high gloss characteristics and ultraviolet (UV) protection to the outer wall of a rubber tire.

### Description of Related Art

Purchasing a new vehicle is a substantial investment. Whether an individual is purchasing a brand new vehicle or a used vehicle, the individual expects the interior and exterior to appear new or well-maintained. Tire manufacturers may apply a dressing to the outer wall of vehicle tires to provide a clean, high gloss appearance and to protect the rubber from ultraviolet light, dirt and grime. Similarly, car dealers and auto detail shops desire to present new and used cars in a new or well-maintained condition, respectively, and may apply a tire dressing composition to the tires of a vehicle to provide a high gloss, or “wet-look” finish and protect the tire surface. Since the high gloss appearance of the outer wall of tires is an indicator of a new vehicle or a clean and well-maintained vehicle, individual car owners may also desire to apply a tire dressing to their vehicle tires.

There are many existing tire cleaning and dressing products on the market. However, many of the existing products are solvent-based and breakdown tires and brake pads causing material fatigue. Thus, these products decrease the life of not only the tires, but the brakes as well. Certain tire dressing products have a low viscosity such that the tire dressing product drips on other parts of the vehicle, damaging the finish of vehicle panels and hubcaps. Further, existing tire dressing products do not properly adhere to the outer wall of the tire or fail to dry or cure. These products only temporarily impart a high gloss finish, but then turn brown from dirt and dust. These products also are not waterproof and wash off easily, especially during precipitation, and need to be reapplied frequently. Other tire dressing products cause the surface of the tire to look hazy as the product wears. Many of the existing tire dressing products are flammable and are harmful to the environment and to the individual applying the product. For example, certain tire dressing products contain petroleum distallates or polysiloxanes. Moreover, since silicone interferes with paint applications, products containing silicone are not desired, and in fact, are banned from some automotive shops.

### BRIEF SUMMARY OF THE INVENTION

In view of the foregoing, it is an object of the present disclosure to provide an aqueous tire dressing composition and method of treating a surface of a rubber tire with the tire dressing.

An aqueous tire dressing composition is provided comprising an acrylic resin, a polyacrylate and a liquid carrier. An exemplary aqueous tire dressing comprises the following ingredients whereby the percent by weight is based on the total weight of the composition: acrylic resin in an amount of 40 to 70 total weight percent, polyacrylate in an amount of about 4 to 22 total weight percent and liquid carrier in an amount from about 10 to about 35 total weight percent.

A method of treating a surface of a tire is provided comprising the steps of applying a first coat of the aqueous tire dressing composition comprising an acrylic resin, a polyacrylate and a liquid carrier, allowing the aqueous tire dressing to dry for an effective period of drying time, applying a second coat of the aqueous tire dressing composition to the surface of the tire, and allowing the aqueous tire dressing to cure for an effective period of curing time for achieving a clear, tack-free protective layer on the surface of the tire. The method may include the step of applying at least a third coat of the aqueous tire dressing composition to the surface of the tire before allowing the aqueous tire dressing to cure. The method may include the step of cleaning the surface of the tire with a detergent, rinsing the surface of the tire with water, and drying the surface of the tire before applying the aqueous tire dressing composition.

### BRIEF DESCRIPTION OF THE SEVERAL VIEWS OF THE DRAWING(S)

FIG. 1 is a flowchart disclosing the method steps of an embodiment for treating a surface of a tire.

### DETAILED DESCRIPTION OF THE INVENTION

At the outset, it should be clearly understood that like reference numerals are intended to identify the same elements, portions or surfaces consistently throughout the several drawing FIGURES, as such elements, portions or surfaces may be further described or explained by the entire written specification, of which this detailed description is an integral part. Unless otherwise indicated, the drawings are intended to be read together with the specification, and are to be considered a portion of the entire written description of this invention.

Tire dressings compositions are available that, after applying to a rubber surface impart a durable protective coating. The tire dressing compositions may also be a “glossy” coating. By “glossy” it is meant that the tire dressing, once died, provides a clear, shiny and lustrous appearance. The tire dressing composition provide either water resistance or waterproof characteristics to the surface. A water resistant tire dressing is one that can moderately to substantially remain on the tire during and after exposure to water. A waterproof tire dressing is one that can remain on the tire during and after exposure to water without significant degradation of the tire dressing.

The tire dressing composition provides easy application to the surface of a tire. By “surface of a tire” it is meant to refer to the sidewall of the tire, that is, the area between the bead to the tread of the tire, and not the tread itself or the hubcap. The tire dressing composition may be applied by spraying, dabbing or pouring the composition onto an applicator pad and applying the tire dressing composition onto the tire using the applicator pad. In one application, the applicator pad is foam. In alternative applications, the tire dressing composition is applied using different application techniques, including, but not limited to, (i) applying the tire dressing composition onto a towel, cloth, paper towel, sponge, brush, roller, rotating brush, or other form of applicator and (ii) applying the tire dressing directly onto the tire. In one application, the tire dressing composition is applied to a clean and dry surface. For example, the surface to receive the application of the tire dressing may be cleaned of dirt and contaminates, including, but not limited to gasoline, de-icing salts, and oil, and allowed to dry thoroughly. For example, the Dura-Cleaner, available from Dura-Coating Technology at www.dura-coating.com, may be used to clean the surface of the tire before applying the aqueous tire dressing. Alternatively, a detergent or all-purpose cleaner may be used. For re-application on tires previously dressed with the tire dressing composition, the tire surface must be cleaned with at least a substantial portion of tire dressing composition removed before the tire dressing composition is reapplied. Typically, the composition is prepared as a ready-to-use composition. However, the composition may be sold as a concentrate, wherein users dilute the composition with water or another liquid carrier according to certain ratios.

The tire dressing composition may resist absorption into the surface of the tire, which absorption may degrade the surface of the tire or otherwise cause material fatigue of the tire material. For example, in some applications, the tire dressing composition can be characterized as having an absorption resistance in a tire of approximately 10 wt. %. In other applications, the tire dressing composition can be characterized as having an absorption resistance in a tire of less than about 10 wt. %. In other applications, the tire dressing composition is characterized as having an absorption resistance in a tire in the range of approximately 1 wt. % to approximately 5 wt. % and yet other absorption resistance in a tire is in the range of approximately 5 wt. % to approximately 10 wt. %. By “absorption resistance” it is meant to refer to an amount of tire dressing composition that absorbs into the tire after the tire dressing composition is applied to the tire surface.

Preferably, the tire dressing composition applied to a tire is non-yellowing and provides UV and chemical resistance to the surface of the tire forming a protective layer. Further, the tire dressing composition is preferably low V.O.C. and low odor. For example, in one application, the tire dressing composition containers fewer than 100 grams per liter of volatile compounds. The tire dressing composition preferably cures as a clear, rubber-like coating having a surface that does not crack and is tack-free or substantially tack-free. The tire dressing composition has a period of effective dry time for achieving a glossy finish and a period of effective cure time for achieving a high gloss, clear, tack-free, at least water repellant, semi-permanent finish on the surface of a tire. By “dry time”, it is meant to refer to a period of time for the liquid carrier to evaporate substantially from the applied tire dressing. By “cure time,” it is meant to refer to a period of time for the applied tire dressing composition to physically and/or chemically change such that the tire dressing composition is bonded and resists removal from the tire surface by water. In one application, the period of effective dry time for one to three coats of applied tire dressing composition is between 30 and 60 minutes. The period of effective cure time for one to three coats of applied tire dressing composition is 24-36 hours. Preferable tire dressing compositions have a viscosity of 18 seconds #4 Ford Cup at 77 degrees Fahrenheit (25 degrees Celsius) or less. More preferably, the tire dressing composition has a viscosity of 5-18 seconds #4 Ford Cup at 77 degrees Fahrenheit (25 degrees Celsius). Further, the tire dressing composition preferably has a pH in the range of 9.5 or less, and more preferably between 7.0 and 9.5. To provide a high level of moisture vapor barrier protection, the tire dressing composition preferably has a percentage of weight solids in the range of approximately 15% to 32%. In another application, the tire dressing composition has a percentage of weight solids of approximately 25%.

The tire dressing composition can include the high gloss components and a liquid carrier as further described below.

High Gloss Component(s)

The tire dressing composition can include at least one gloss imparting component wherein application of the tire dressing composition to the surface of a tire imparts a high gloss value. The high gloss imparting component does not include a siloxane group or repeating siloxane groups, for example such as repeating dimethylsiloxane groups. Further, in an application of the tire dressing composition, the high gloss imparting component(s) does not include urethane. One example of gloss imparting components that can be used is water-based acrylic resins. Preferably, the tire dressing composition includes at least 55% by weight acrylic resin, however, the gloss imparting components may range between 55% and 100% by weight acrylic resin, and more preferably between 55% and 70% by weight acrylic resin, and more preferably 60% and 66% by weight acrylic resin. The acrylic resin can be obtained from commercially available sources of water-based acrylic resins. For example, Valspar® Wet Look High Gloss Sealer, also known as Drylok® Wetlook High Gloss Sealer, available from United Gilsonite Laboratories, can be included in the tire dressing composition. Further, anionic polyacrylate can be included in the tire dressing. Preferably, the tire dressing composition includes at least 5% by weight anionic polyacrylate, and more preferably, between 5% and 30% by weight anionic polyacrylate, and even more preferably between 5% and 11% by weight anionic polyacryate. The anionic polyacrylate can be obtained from commercially available sources of water-based products. For example, Ure Seal (Part A) from Innovative Concreate Technology Corporation can be included in the tire dressing composition. In one application, the tire dressing composition includes at least 20% by weight of Ure Sealer H₂O and at least 50% by weight Valspar® Wet Look High Gloss Sealer.

Carrier

The tire dressing composition is preferably water based and not solvent based. Thus, water is typically used in the formulation of the tire dressing composition. The tire dressing composition includes a carrier in an amount ranging from 15% to 35% by weight and more preferably in an amount ranging from 20% to 30% by weight. One application comprises 23% of water based on the total weight of the composition. Preferably, the water is reverse osmosis water or water otherwise purified of ions and undesired particles and molecules. After application of the tire dressing composition, water will evaporate from the tire dressing composition. In one application, an amount of water is used which will allow one to three coats of tire dressing composition to dry in approximately 60 minutes, and more preferably, to dry in approximately 30 to 60 minutes.

To prepare the tire dressing composition, the ingredients of the tire dressing may be mixed in any effective amount. Generally the high gloss components acrylic resin and polyacrylate are in amounts of 55% and 70% by weight acrylic resin and between 5% and 30% by weight polyacrylate. The period of effective cure time for one to three coats of applied tire dressing composition is preferably approximately 36 hours, and more preferably in the range of approximately 24-36 hours. Over this cure time period, in one application, the coatings of tire dressing composition transition from a cloudy or whitish, milky color to a clear, tack-free protective layer.

The present invention is further described according to the following non-limiting examples that are provided to further illustrate the preparation of the tire dressing composition and certain attributes associated with the resulting application on the surface of a tire.

### Example 1

### Tire Dressing Composition

In one application of the invention, the tire dressing composition is as follows:

| Component | % |
|---|---|
| Ure Sealer H2O Part A | 22% |
| Valspar Wet Sealer | 55% |
| Water | 23% |

The Ure Sealer H20 Part A, Valspar Wet Sealer, and water are added to a container and mechanically mixed for approximately 5 minutes forming a watery, milky white colored liquid. The components are mixed at a temperature that is preferably above 55 degrees Fahrenheit and below 75 degrees Fahrenheit. The composition set forth in Example 1 results in a composition that, when applied to a tire surface, forms a clear substance that imparts a long-lasting high gloss or sheen characteristic to the surface.

### Example 2

### Tire Dressing Composition

In another application of the invention, the tire dressing composition is as follows:

| Component | % |
|---|---|
| Valspar Wet Sealer | 75% |
| Water | 25% |

The Valspar Wet Sealer and water are added to a container and mechanically mixed for approximately 5 minutes forming a watery, milky white colored liquid. The components are mixed at a temperature that is preferably above 55 degrees Fahrenheit and below 75 degrees Fahrenheit. The composition set forth in Example 2 results in a composition that, when applied to a tire surface, forms a clear substance that imparts a high gloss or sheen characteristic to the surface. While the high gloss characteristics will remain for a prolonged period, this composition will typically adhere to the tire surface for less than 1 year.

### Example 3

### Tire Dressing Composition

In another application of the invention, the tire dressing composition is as follows:

| Component | % |
|---|---|
| Valspar Wet Sealer | 100% |

The Valspar Wet Sealer alone, when applied to a tire surface, forms a clear substance that imparts a long-lasting high gloss or sheen characteristic to the surface. It should be appreciated that, while Valspar Wet Sealer may be used without diluting the composition with water, the composition may dry quicker, making application of the composition more difficult. Further, the product may not have the same longevity as the mixture with Ure Sealer H2O Part A, and will typically adhere to the tire surface for less than 1 year.

Method of Application

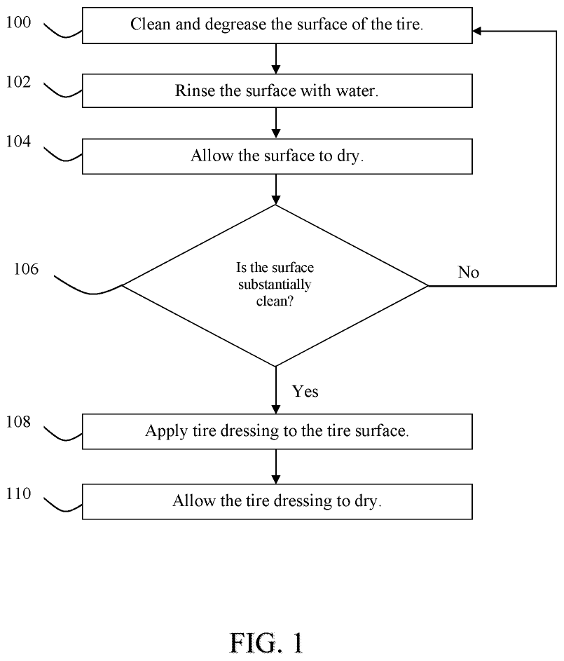

FIG. 1 presents a method of treating a surface of a tire. At the outset, it should be appreciated that prior to applying the tire dressing composition to a surface, the surface must be clean. That is, the surface must be at least substantially free of grease, salt, and dirt. Thus, according to step 100, the surface of the tire is cleaned and degreased with a detergent. In an exemplary application, the product used to prepare the surface of a tire is Dura-Cleaner Heavy Duty Tire Cleaner sold by Dura-Coating Technology Inc. and available at dura-coating.com. For example, the Dura-Cleaner can be applied to the tire and brushed along sections of the tire. In an exemplary application, the Dura-Cleaner is not misted onto the surface, but rather, sprayed directly on the tire by placing the nozzle of the Dura-Cleaner sprayer on the tire surface itself. However, other techniques for applying the Dura-Cleaner can be used. Once the tire surface is thoroughly scrubbed, the cleaning product is rinsed according to step 102 and the tire is allowed to dry, or mostly dry, according to step 104. For example, another tire or tires may be cleaned while waiting for the first cleaned tire(s) to dry. The next step, according to step 106, is to determine if the tire surface is substantially clean for purposes of applying the tire dressing composition. To test the tire surface, the Dura-Cleaner or alternative detergent, can be applied to the tire surface a second time, allowing the product to stand for at least 1 minute and more preferably, between 1 minute and 5 minutes, and even more preferably between 1 minute and 1.5 minutes. If the suds of the Dura-Cleaner or alternative detergent appear brown or yellow, the surface is not clean enough to proceed with the application of the tire dressing and the cleaning process needs to be repeated according to steps 100, 102 and 104. That is, the tire is rinsed, dried, the Dura-Cleaner or alternative detergent is reapplied according to step 100, and the tire scrubbed. As set forth in step 102, the surface is rinsed with water according to step 102 and the surface allowed to dry according to step 104. Again, it is determined if the surface is substantially clean for purposes of applying the tire dressing composition. The Steps 100-106 are repeated until the tire surface is no longer dirty. Any tire dressing formerly applied to the surface and not releasing with cleaner can be removed with lacquer thinner and wiped dry in between applications of the Dura-Cleaner. It should be appreciated that formerly applied tire dressings can interfere with the tire dressing composition adherence to the surface of the tire, and cause the tire dressing to lack a high gloss shine, especially silicone-based tire dressings. Thus, it can be important to fully remove any formerly applied tire dressings before applying the tire dressing composition. If the suds do not appear brown or yellow, the surface is clean enough for the application of the tire dressing composition.

Once the tire surface is substantially clean and dried, the tire dressing composition can be applied to the tire surface according to step 108.

Preferably, the tire dressing composition is mixed well before applying the tire dressing composition to the surface of a tire. Typically, the tire dressing is applied to an applicator pad and spread onto the tire surface using linear and circular motions to form a first coat on the tire. In one application, the applicator pad is foam. In another application, the applicator pad is microfiber. In yet another application, the tire dressing composition is applied using other types of applicators, including, but not limited to, a towel, cloth, paper towel, sponge, brush, roller, or rotating brush. Any excess or standing tire dressing should be blotted or dabbed off the tire. Typically, the thickness of the first coat of tire dressing composition is approximately 4 wet mils or less. As the tire dressing dries according to step 110, the tire dressing may be smoothed out. Preferably, the tire dressing is allowed to dry for at least 5 minutes, and more preferably 20 minutes, and more preferably between 30 minutes and 60 minutes, before a second coat of tire dressing is applied. Typically, the thickness of the second coat of tire dressing composition is approximately 4 wet mils or less. If the desired high gloss appearance is not achieved with the first coat, steps 108 and 110 may be repeated for an additional two to four coats. Typically, 1-2 coats of tire dressing provides a matte finish and the third and fourth coats of tire dressing provide a high gloss finish.

Ideally, the tires will remain dry for 12-24 hours after applying the tire dressing. The tire dressing composition is fully cured 24-36 hours after the last coat of tire dressing is applied in temperatures ranging from approximately 55 degrees Fahrenheit to 90 degrees Fahrenheit. Cure times and dry times in between coats may increase in cooler temperatures. Moreover, cure times may shorten in direct sunlight and preferably, the tire dressing composition is not applied in direct sunlight.

Once the tire dressing composition cures, the tire dressing is semi-permanent and will typically adhere to the tire surface for at least 1 year. After the tire dressing composition is cured, the tires may be washed with mild soap and water without inhibiting the high gloss shine. If necessary, one or two light coats of the tire dressing composition may be re-applied every 6-12 weeks to maintain the high gloss appearance.

The tire dressing composition is a watery, milky substance that dries as a clear-coating which is flexible and does not crack. It is easy to apply with a reasonable working time.

The tire dressing composition imparts many desired features on the surface of the tire, including but not limited to, providing a UV-protective, waterproof, and highly glossy finish to the surface of the tire. Since the tire dressing composition is not solvent based, it generally does not affect or breakdown the rubber of the tire.

The foregoing examples of the invention are representative, and are provided for illustrative purposes. The examples are not intended to limit the scope of the invention. Variations and modifications are apparent from a reading of the preceding description and are included within the scope of the invention. The invention is intended to be limited only by the scope of the accompanying claims.

1. An aqueous tire dressing composition comprising:
an acrylic resin;
polyacrylate; and
a liquid carrier.

2. The aqueous tire dressing composition of claim 1, wherein the acrylic resin is present in an amount from about 40 to about 70 total weight percent.

3. The aqueous tire dressing composition of claim 1, wherein the polyacrylate is present in an amount from about 4 to about 22 total weight percent.

4. The aqueous tire dressing composition of claim 1, wherein the liquid carrier is present in an amount from about 10 to about 35 total weight percent.

5. The aqueous tire dressing composition of claim 1, wherein the acrylic resin is present in an amount from about 40 to about 70 total weight percent, wherein the polyacrylate is present in an amount from about 4 to about 22 total weight percent, and wherein the liquid carrier is present in an amount from about 10 to about 35 total weight percent.

6. The aqueous tire dressing composition of claim 1, wherein the absorption resistance on a surface of a tire is in the range of approximately 1 weight percent to approximately 5 weight percent.

7. The aqueous tire dressing composition of claim 1, wherein the tire dressing composition contains fewer than 100 grams per liter of volatile compound.

8. A method of treating a surface of a tire comprising using the aqueous tire dressing composition of claim 1, the method comprising:
applying a first coat of the aqueous tire dressing composition to the surface of the tire;
allowing the aqueous tire dressing to dry for an effective period of drying time;
applying a second coat of the aqueous tire dressing composition to the surface of the tire; and
allowing the aqueous tire dressing to cure for an effective period of curing time for achieving a clear, tack-free protective layer on the surface of the tire.

9. The method of claim 8, further comprising the steps of:
cleaning the surface of the tire with a detergent;
rinsing the surface of the tire with water; and
drying the surface of the tire before applying the aqueous tire dressing composition.

10. The method of claim 8, further comprising the step of applying at least a third coat of the aqueous tire dressing composition to the surface of the tire before allowing the aqueous tire dressing to cure.

11. The method of claim 9, further comprising the steps of:
determining whether the surface of the tire is clean; and
if the surface of the tire is not clean, repeat the steps of claim 9.

12. The method of treating a surface of a tire of claim 8 wherein the effective period of drying time is between approximately 30 and 60 minutes.

13. The method of treating a surface of a tire of claim 8 wherein the effective period of curing time is between approximately 24 and 26 hours.

14. The method of treating a surface of a tire of claim 8 wherein the aqueous tire dressing composition is applied to the surface of the tire with an applicator pad.

15. The method of treating a surface of a tire of claim 8 further comprising applying at least a third coat of the aqueous tire dressing composition to impart a glossy finish on the tire surface when the aqueous tire dressing composition is dry.

16. The method of treating a surface of a tire of claim 8 wherein the protective layer remains on the surface of the tire for approximately one year.

17. The method of treating a surface of a tire of claim 8 wherein each of the first coat and the second coat of the aqueous tire dressing composition is 4 wet mils or less.
